(19) United States
(12) Patent Application Publication
(10) Pub. No.: US 2007/0116904 A1
(43) Pub. Date: May 24, 2007

(54) Microporous inkjet recording material

(76) Inventor: Radha Sen, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/286,091

(22) Filed: Nov. 23, 2005

(51) Int. Cl. B41M 5/40

(52) U.S. Cl. 428/32.34

(57) ABSTRACT

An ink receiving substrate includes a base substrate, and a microporous coating formed on the base substrate, wherein the microporous coating includes a high surface area fumed alumina and a high molecular weight polyvinyl alcohol (PVA) binder.

### BACKGROUND

Inkjet printing has become a popular way of recording images on various media surfaces, particularly paper, for a number of reasons, including, low printer noise, capability of high-speed recording, and multi-color recording. Additionally, these advantages of inkjet printing can be obtained at a relatively low price to consumers. Though there has been great improvement in inkjet printing, improvements are followed by increased demands from consumers for higher speeds, higher resolution, full color image formation, increased stability, etc.

In recent years, as digital cameras and other digital image collecting devices have advanced, image recording technology has attempted to keep pace by improving inkjet image recording on paper sheets and the like. The desired quality level of the inkjet recorded images (“hard copy”) is that of traditional silver halide photography. In other words, consumers would like inkjet recorded images that have the color reproduction, image density, gloss, etc. that is as close to those of silver halide photography as possible.

Traditional recording sheets for the inkjet printing process are not adequate to provide silver halide quality images. Particularly, there is a need to improve ink absorption capacity, ink absorption rate or dry time, image quality, and gloss.

### SUMMARY

In one aspect of the present system and method, an ink receiving substrate includes a base substrate and a microporous coating formed on the base substrate. The microporous coating includes a high surface area fumed alumina and a high molecular weight polyvinyl alcohol binder.

In another embodiment, a method for forming an ink receiving substrate includes providing a base substrate, combining a high surface area fumed alumina with a high molecular weight polyvinyl alcohol binder to form a coating, and dispensing a layer of the coating on at least one surface of the base substrate.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 is a simple block diagram illustrating an inkjet material dispensing system, according to one exemplary embodiment.

FIG. 2 is a side cross-sectional view illustrating the layers of a microporous inkjet recording substrate, according to one exemplary embodiment.

FIG. 3 is a flow chart illustrating a method for forming a microporous coating, according to one exemplary embodiment.

Throughout the drawings, identical reference numbers designate similar, but not necessarily identical, elements.

### DETAILED DESCRIPTION

The present specification discloses an exemplary microporous ink recording material having improved ink dry time, gloss, and capacity compared to microporous ink recording materials incorporating low surface area fumed alumina materials. According to one exemplary embodiment disclosed herein, the microporous ink recording material includes a layer of high surface area fumed alumina such as VP Alu 3. Further details of the present ink recording material will be provided below.

Before particular embodiments of the present system and method are disclosed and described, it is to be understood that the present system and method are not limited to the particular process and materials disclosed herein as such may vary to some degree. It is also to be understood that the terminology used herein is used for the purpose of describing particular embodiments only and is not intended to be limiting, as the scope of the present system and method will be defined only by the appended claims and equivalents thereof.

As used in the present specification and in the appended claims, the term “ink” is defined to include liquid compositions that can include colorants, such as pigments and/or dyes, as well as liquid vehicles configured to carry the colorants to a substrate. Liquid vehicles are well known in the art, and a wide variety of liquid vehicle components may be used in accordance with embodiments of the present exemplary system and method. Such liquid vehicles may include a mixture of a variety of different agents, including without limitation, surfactants, co-solvents, buffers, biocides, viscosity modifiers, sequestering agents, stabilizing agents, and water. Though not liquid per se, the liquid vehicle can also carry other solids, such as polymers, UV curable materials, plasticizers, salts, etc.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of approximately 1 wt % to about 20 wt % should be interpreted to include not only the explicitly recited concentration limits of 1 wt % to about 20 wt %, but also to include individual concentrations such as 2 wt %, 3 wt %, 4 wt %, and sub-ranges such as 5 wt % to 15 wt %, 10 wt % to 20 wt %, etc.

As used in the present specification and the appended claims, the term “high surface area fumed alumina” is meant to be understood as including any fumed alumina particles having a surface area greater than approximately 110 m² per gram.

Additionally, as used herein, the term “high molecular weight polyvinyl alcohol binder” or “high molecular weight PVA binder” shall be interpreted as including any polyvinyl alcohol based binder having a molar mass of 300,000 grams per mol or more. According to one exemplary embodiment, high molecular weight polyvinyl alcohol binders shall be interpreted as including, but not being limited to, Poval 235 and Poval 245, manufactured by Kuraray America, Inc.

In the following description, for purposes of explanation, numerous specific details are set forth in order to provide a thorough understanding of the present system and method for producing an exemplary microporous ink recording material having improved ink dry time, gloss, and ink capacity. It will be apparent, however, to one skilled in the art, that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Exemplary Structure

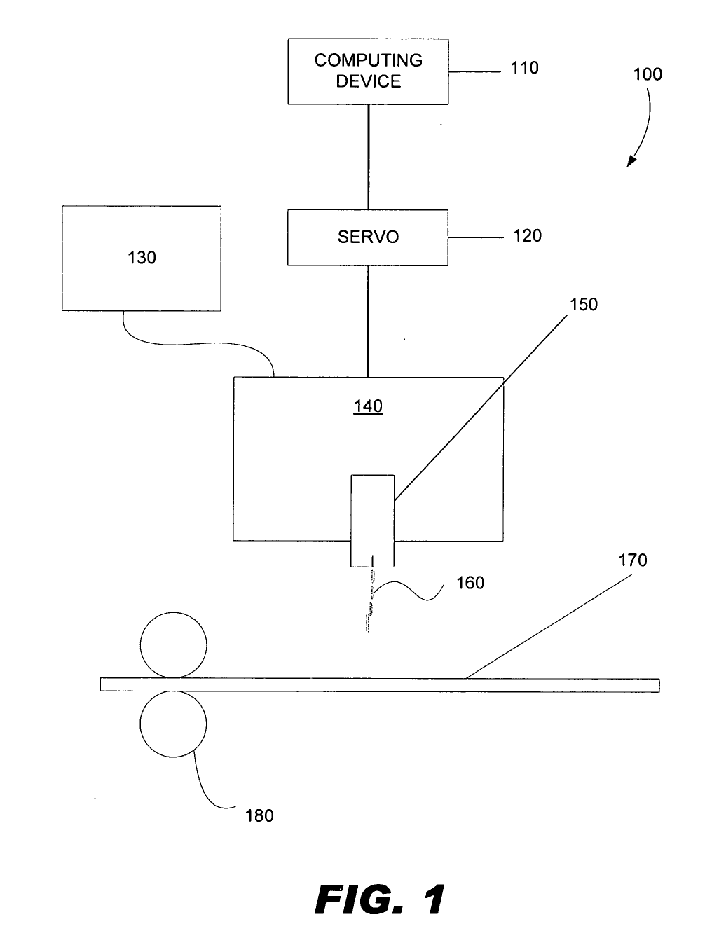

FIG. 1 illustrates an exemplary system (100) that may be used to apply a pigment-based inkjet ink (160) to an ink receiving structure (170), according to one exemplary embodiment. As shown in FIG. 1, the present system includes a computing device (110) controllably coupled through a servo mechanism (120) to a moveable carriage (140) having an inkjet dispenser (150) disposed thereon. A material reservoir (130) is coupled to the moveable carriage (140), and consequently to the inkjet print head (150). A number of rollers (180) are located adjacent to the inkjet dispenser (150) configured to selectively position an ink receiving structure (170). The above-mentioned components of the present exemplary system (100) will now be described in further detail below.

The computing device (110) that is controllably coupled to the servo mechanism (120), as shown in FIG. 1, controls the selective deposition of an inkjet ink (160) on an ink receiving structure (170). A representation of a desired image or text may be formed using a program hosted by the computing device (110). That representation may then be converted into servo instructions that are then housed in a processor readable medium (not shown). When accessed by the computing device (110), the instructions housed in the processor readable medium may be used to control the servo mechanisms (120) as well as the movable carriage (140) and inkjet dispenser (150). The computing device (110) illustrated in FIG. 1 may be, but is in no way limited to, a workstation, a personal computer, a laptop, a digital camera, a personal digital assistant (PDA), or any other processor containing device.

The moveable carriage (140) of the present printing system (100) illustrated in FIG. 1 is a moveable material dispenser that may include any number of inkjet material dispensers (150) configured to dispense the inkjet ink (160). The moveable carriage (140) may be controlled by a computing device (110) and may be controllably moved by, for example, a shaft system, a belt system, a chain system, etc. making up the servo mechanism (120). As the moveable carriage (140) operates, the computing device (110) may inform a user of operating conditions as well as provide the user with a user interface.

As an image or text is printed on the ink receiving structure (170), the computing device (110) may controllably position the moveable carriage (140) and direct one or more of the inkjet dispensers (150) to selectively dispense an inkjet ink at predetermined locations on the ink receiving structure (170) as digitally addressed drops, thereby forming the desired image or text. The inkjet material dispensers (150) used by the present printing system (100) may be any type of inkjet dispenser configured to perform the present method including, but in no way limited to, thermally actuated inkjet dispensers, mechanically actuated inkjet dispensers, electrostatically actuated inkjet dispensers, magnetically actuated dispensers, piezoelectrically actuated dispensers, continuous inkjet dispensers, etc. Additionally, the present ink receiving structure (170) may receive inks from non-inkjet sources such as, but in no way limited to, screen printing, stamping, pressing, gravure printing, and the like.

The material reservoir (130) that is fluidly coupled to the inkjet material dispenser (150) houses and supplies an inkjet ink (160) to the inkjet material dispenser. The material reservoir may be any container configured to hermetically seal the pigment-based inkjet ink (160) prior to printing.

FIG. 1 also illustrates the components of the present system that facilitate reception of the pigment and/or dye-based inkjet ink (160) onto the ink receiving structure (170). As shown in FIG. 1, a number of positioning rollers (180) may transport and/or positionally secure an ink receiving structure (170) during a printing operation. Alternatively, any number of belts, rollers, substrates, or other transport devices may be used to transport and/or positionally secure the ink receiving structure (170) during a printing operation, as is well known in the art.

The present system and methods provide a porous ink receiving structure (170) with enhanced image quality, the composition of which will now be described in detail below.

Exemplary Composition

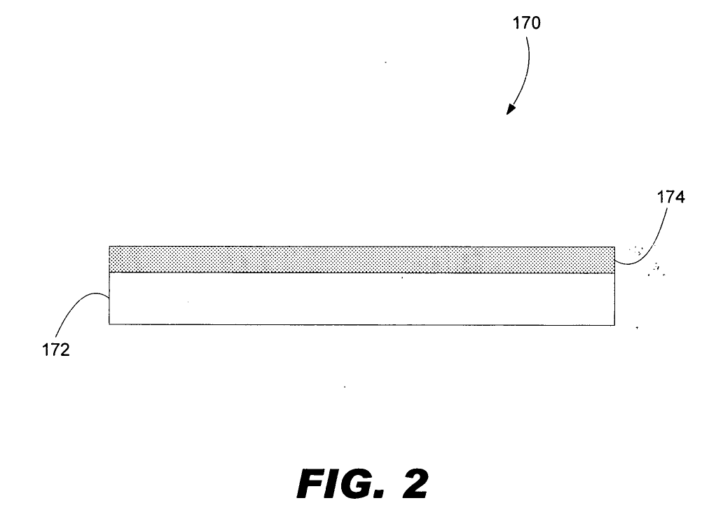

One exemplary composition of the present exemplary ink receiving structure (170) configured to receive an inkjet ink (160) is illustrated in FIG. 2. As shown in FIG. 2, the present exemplary ink receiving structure (170) includes a resin coated base layer (172), and a layer of high surface area fumed alumina (174) formed thereon. As a result of the present formulation, the disclosed ink receiving structure (170) improves the ink dry time, gloss, and ink capacity over low surface area fumed alumina materials. Additionally, a number of issues such as high shear mixing and cationic conversion that often accompany the use of silica powder are avoided. The individual components of the present ink receiving structure (170) will be described in further detail below.

Resin Coated Base Paper

The present exemplary ink receiving structure (170) is formed on a resin coated base layer (172) or support. According to one exemplary embodiment, any number of the usual resin coated base supports used in the manufacture of transparent or opaque photographic material may also be employed in the practice of the present system and method. Examples include, but are not limited to, clear films, such a cellulose esters, including cellulose triacetate, cellulose acetate, cellulose propionate, or cellulose acetate butyrate, polyesters, including poly(ethylene terephthalate), polyimides, polycarbonates, polyamides, polyolefins, poly(vinyl acetals), polyethers, polyvinyl chloride, and polysulfonamides. Polyester film supports, and especially poly(ethylene terephthalate), such as manufactured by du Pont de Nemours under the trade designation of MELINEX, may be selected because of their excellent dimensional stability characteristics. Further, opaque photographic materials may be used as the resin coated base layer (172) including, but in no way limited to, baryta paper, polyethylene-coated papers, and voided polyester.

Non-photographic materials, such as transparent films for overhead projectors, may also be used for the support material. Examples of such transparent films include, but are not limited to, polyesters, diacetates, triacetates, polystyrenes, polyethylenes, polycarbonates, polymethacrylates, cellophane, celluloid, polyvinyl chlorides, polyvinylidene chlorides, polysulfones, and polyimides.

While the present exemplary ink receiving structure (170) is described within the context of utilizing a resin coated base layer (172), any number of additional support materials may be used as a base layer by the present exemplary system and method. Additional support materials that may be incorporated by the present system and method to serve as the resin coated base layer (172) include plain paper of various different types, including, but in no way limited to, plain papers, pigmented papers, and cast-coated papers, as well as metal foils, such as foils made from alumina.

High Surface Area Fumed Alumina

As illustrated in FIG. 2, the resin coated base layer (172) is coated on at least one surface with a high surface area fumed alumina (174). The dry coatweight of the layer of high surface area fumed alumina (174) is about 20 to 55 GSM but preferably from 25 to 35 GSM. According to one exemplary embodiment, the layer of high surface area fumed alumina (174) includes both a high surface area fumed alumina and a high molecular weight polyvinyl alcohol (PVA) binder as defined previously. The resulting formulation provides higher gloss and faster dry times than possible with low surface area fumed alumina while maintaining higher ink capacity and greater ease of manufacturability. Further details of the individual components of the high surface area fumed alumina layer (174) will be provided below.

According to one exemplary embodiment, the resin coated base layer (172) is coated with high surface area fumed alumina layer (174). The high surface area fumed alumina is mixed with a high molecular weight PVA binder and then disposed on the resin coated base layer (172). According to this exemplary embodiment, the high surface area fumed alumina may be any fumed alumina having an aggregate size between approximately 100-110 nm. Additionally, according to the present exemplary embodiment, the phrase “high surface area fumed alumina” will be meant to include any fumed alumina having a surface area greater than approximately 110 m²/gram. Commercially available examples of high surface area fumed alumina include, but are in no way limited to, VP Alu 3® powder supplied by Degussa Company.

According to one exemplary embodiment, the use of the high surface area fumed alumina provides higher gloss than traditional fumed silica due to the increased surface area. Specifically, the high surface area fumed alumina generates a higher glossed surface area due to the increased surface area exposed by the resin coated base layer. Additionally, the dry time and ink capacity associated with the high surface area fumed alumina is increased.

However, according to one exemplary embodiment, the high surface area fumed alumina may be more prone to cracking than fumed alumina. Consequently, one exemplary embodiment of the present high surface area fumed alumina layer (174) includes a very high molecular weight polyvinyl alcohol binder. According to one exemplary embodiment, any number of high molecular weight PVA binders may be used in connection with the high surface area fumed alumina including, but in no way limited to, Poval 235 and Poval 245, commercially available from Kuraray, Inc.

According to the present exemplary embodiment, the binder/fumed alumina ratio is from approximately 10 to 40 parts based on the fumed alumina. The incorporation of a high molecular weight PVA binder reduces the likelihood of cracking due to the high surface area of the pigment.

In addition to the above-mentioned components, the high surface area fumed alumina layer (174) may also contain any number of surfactants, buffers, plasticizers, and other additives that are well known in the art. According to one exemplary embodiment, a buffer such as boric acid may be included in quantities of approximately 1.0 to 1.2% wt.

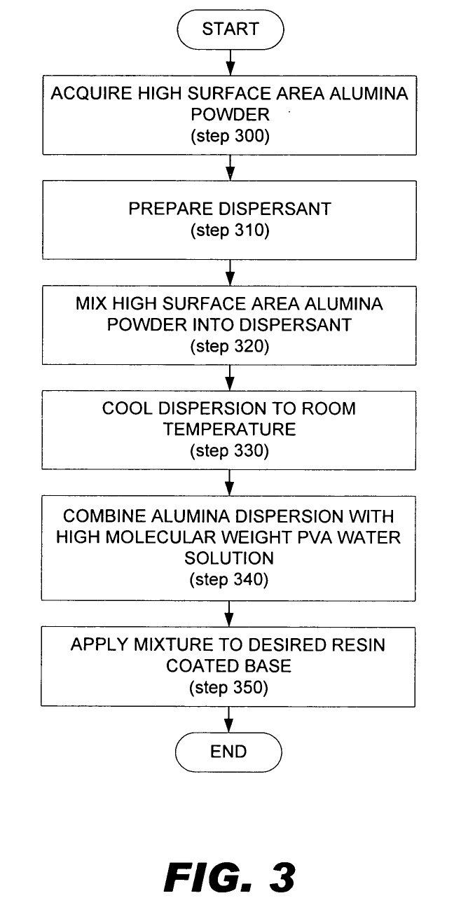

During application, the high surface area fumed alumina layer (174) can be coated onto the resin coated base layer (172) by any number of material dispensing machines and/or methods including, but in no way limited to, a slot coater, a curtain coater, a cascade coater, a blade coater, a rod coater, a gravure coater, a Mylar rod coater, a wired coater, and the like. Further details of the method of formation of the present exemplary high surface area fumed alumina layer will be provided below with reference to FIG. 3.

Exemplary Formation

FIG. 3 illustrates a method for forming the present high surface area fumed alumina layer (174) on a resin coated base layer (172), according to one exemplary embodiment. As illustrated in FIG. 3, the present exemplary formation method begins by first acquiring a high area fumed alumina powder (step 300). As mentioned previously, VP Alu 3® powder of Degussa Company is one example of appropriate high area fumed alumina powder.

Once the powder is acquired, a dispersant is prepared (step 310). According to one exemplary embodiment, the dispersant may be an acetic acid solution in deionized water. The amount of dispersant used may vary depending on the weight percent of desired solids in the final dispersion. According to one exemplary embodiment targeting approximately 45% wt solids, a 4% wt of acetic acid solution in deionized water may be prepared.

With the high area fumed alumina powder acquired (step 300) and the dispersant prepared (step 310), the next step in the preparation of the high surface area fumed alumina layer (174; FIG. 2) includes mixing the high area fumed alumina powder into the dispersant (step 320). According to one exemplary embodiment, the high area fumed alumina powder is mixed into the dispersant using a partially baffled mixing tank and a low to medium shear disperser such as impeller type mixers including, but in no way limited to a Rushton turbine. In contrast to fumed silica, the present exemplary high surface area fumed alumina may be dispersed with low to medium shear dispersers while providing high gloss and high ink capacity.

With the alumina powder incorporated into the dispersion, the dispersion is allowed to cool (step 330) to room temperature. Once cooled appropriately, the fumed alumina dispersion may then be combined with a high molecular weight PVA water solution (step 340). According to one exemplary embodiment, the step of combining the high surface area fumed alumina dispersion with the high molecular weight PVA water solution (step 340) includes adding a desired amount of the high molecular weight PVA water solution into the fumed alumina dispersion followed by mixing and the inclusion of appropriate amounts of deionized water and boric acid to maintain a desired solid % wt and pH.

With the high surface area fumed alumina mixture prepared, it may then be applied to a desired resin coated base (step 350). According to one exemplary embodiment, the high surface area fumed alumina mixture may be applied to a desired resin coated base layer (step 350) using any number of known coating techniques including, but in no way limited to, a slot coater, a curtain coater, a cascade coater, a blade coater, a rod coater, a gravure coater, a Mylar rod coater, a wired coater, and the like. Further details and examples of the present exemplary high surface area fumed alumina mixture, as well as its performance compared to traditional coating will be provided below.

### EXAMPLE

According to a first exemplary embodiment, a plurality of coating mixtures were produced using the exemplary method illustrated in FIG. 3. In generating the plurality of coating mixtures, a first mixture was generated using VP Alu 3® powder from Degussa Company as a high surface area fumed alumina example. Additionally, a second mixture was prepared using AluC® from the Degussa Company as a standard fumed alumina example. The generated mixtures were then applied to a number of substrates and evaluated for: a) water capacity; b) gloss (at 20°, 60°, and 85°); c) smudge drying time; d) coalescence; e) gamut and f) cracks. Further details of the mixture preparations, as well as the evaluation results are provided below.

A first mixture was generated using VP Alu 3® powder from Degussa Company as a high surface area fumed alumina example. The dispersion prepared for the study targeted 45% wt as final solids using 4% wt of Acetic Acid solution in D.I. Water as dispersant. The preparation of dispersion was done by mixing the VP Alu 3® powder into the dispersant using partially baffled mixing tank and a Rushton turbine (6 blades turbine of θ=1.5″). The rotational speed was set to allow good visible vertical circulation and varied from approximately 650 rpm at the beginning to approximately 4,000 rpm at the end of the process. After all of the powder was incorporated into dispersion the mixing process was allowed for additional 20 minutes and the samples for the actual solids content and particles size distribution were taken. Finally, the dispersion was allowed to sit for approximately 2 hours to allow it to cool down to room temperature and viscosity and pH measurements were taken. At this point the dispersion was ready for use in the preparation of the coating mixtures (the lacquers).

With the dispersion prepared, the lacquers (coating mixtures) were generated by adding the desired amount of PVA's water solution into the dispersion, mixed well followed with adding necessary amount of D.I. water and boric acid while mixing. Lacquers were prepared using both high and low molecular weight PVA binders. Each mixture was stirred for additional 5-10 minutes, sampled for solids, particle size and aged over night and sampled for viscosity and pH before coating.

Similarly, a second mixture was prepared using AluC® from the Degussa Company as a standard fumed alumina example. Two different dispersions were prepared for the study: 1) A20 and 2) A40. Both dispersions are targeted 45% wt as final solids using 2% wt and 4% wt of Acetic Acid solutions in D.I. Water respectively as dispersant. The preparation of dispersions were done by mixing the AluC® powder into the dispersant using partially baffled mixing tank and a Rushton turbine (6 blades turbine of θ=1.5″). The rotational speed was set to allow good visible vertical circulation and varied from approximately 650 rpm at the beginning to approximately 1,800 rpm at the end of the process. After all of the powder was incorporated into dispersion the mixing process was allowed for additional 20 minutes and the samples for the actual solids content and particles size distribution were taken. Finally, the dispersion was allowed to sit for approximately 2 hours to allow it to cool down to room temperature and the measurement for viscosity and pH was taken. At this point the dispersion was ready for use in the preparation of the coating mixtures (the lacquers).

The coating mixtures (the lacquers) were prepared by adding the desired amount of PVA water solution into the A20 or A40 dispersion, mixed well followed with adding necessary amount of D.I. water and boric acid while mixing. Again, both high density and low density PVA binders were used in various lacquer mixtures. Each mixture was stirred for additional 5-10 minutes, sampled for solids, particle size and let aged over night and sampled for viscosity and pH before coating.

With the experimental coatings prepared, the coatings were applied on a resin coated paper. Five sheets were coated of each lacquer with the targeted 35 gsm and dried at 60° C. in a convection oven with air flow. The dry sheets were cut to 11″×8.5″ size and evaluated for: a) water capacity; b) gloss (at 20o, 60o and 85o); c) smudge drying time; d) coalescence; e) gamut and f) cracks.

According to the above-mentioned experiment, both the high surface area fumed alumina (VP Alu 3®)) and the low surface area fumed alumina (AluC®) produced Mercedes cracks when coated with the lower molecular weight PVA binder. However, when combined with the higher molecular weight PVA binder, the cracks were not present for either the high surface area fumed alumina (VP Alu 3®) or the low surface area fumed alumina (AluC®). However, when combined with the high molecular weight PVA binder, the coating incorporating the high surface area fumed alumina (VP Alu 3®) exhibited higher relative capacity, lower smudge drying time, lower coalescence, higher gamut and gloss properties than the coating incorporating the low surface area fumed alumina (AluC®).

In conclusion, the above-mentioned example illustrates a number of benefits that may be provided by the present exemplary system and method, according to one exemplary embodiment. More specifically, the exemplary microporous ink recording material incorporating a layer of high surface area fumed alumina in combination with a high molecular weight binder generates improved ink dry time, gloss, and capacity compared to low surface area fumed alumina.

The preceding description has been presented only to illustrate and describe exemplary embodiments of the present system and method. It is not intended to be exhaustive or to limit the system and method to any precise form disclosed. Many modifications and variations are possible in light of the above teaching. It is intended that the scope of the system and method be defined by the following claims.

What is claimed is:

1. An ink receiving structure comprising:
a base substrate; and
a microporous coating formed on said base substrate;
wherein said microporous coating includes a high surface area fumed alumina and a high molecular weight polyvinyl alcohol (PVA) binder.

2. The ink receiving structure of claim 1, wherein said base substrate comprises a resin coated paper layer.

3. The ink receiving structure of claim 1, wherein said base substrate comprises a clear film.

4. The ink receiving structure of claim 3, wherein said clear film comprises one of a cellulose ester, a polyester, a polyimide, a polycarbonate, a polyamide, a polyolefin, a poly(vinyl acetal), a polyether, a polyvinyl chloride, or a polysulfonamide.

5. The ink receiving structure of claim 1, wherein said base substrate comprises one of a baryta paper, a polyethylene-coated paper, or a voided polyester.

6. The ink receiving structure of claim 1, wherein said resin coated base layer comprises one of a pigmented paper, a cast-coated paper, or a metal foil.

7. The ink receiving structure of claim 1, wherein a dry coatweight of said high surface area fumed alumina comprises between approximately 20 to 55 GSM.

8. The ink receiving structure of claim 7, wherein said high surface area fumed alumina comprises between approximately 25 to 35 GSM.

9. The ink receiving structure of claim 1, wherein said high surface area fumed alumina has an aggregate size between approximately 100 and 110 nm.

10. The ink receiving structure of claim 1, wherein said high surface area fumed alumina has a surface area greater than approximately 110 m²/gram.

11. The ink receiving structure of claim 1, wherein said high surface area fumed alumina comprises VP Alu 3® powder.

12. The ink receiving structure of claim 1, wherein said high molecular weight PVA binder comprises a molar mass greater than approximately 300,000 grams per mol.

13. The ink receiving structure of claim 12, wherein said high molecular weight PVA binder comprises one of Poval 235 or Poval 245.

14. The ink receiving structure of claim 1, wherein said microporous coating comprises a high molecular weight PVA binder/high surface area fumed alumina ratio of from approximately 10 to 40 parts based on the fumed alumina.

15. The ink receiving structure of claim 1, wherein said microporous coating further comprises one of a surfactant, a buffer, or a plasticizer.

16. The ink receiving structure of claim 15, wherein said microporous coating further comprises a buffer in a quantity between approximately 1.0 and 1.2% wt.

17. A method for forming an ink receiving structure comprising:
providing a base substrate;
combining a high surface area fumed alumina with a high molecular weight polyvinyl alcohol binder to form a coating; and
dispensing a layer of said coating on at least one surface of said base substrate.

18. The method of claim 17, wherein said step of dispensing a layer of said coating on at least one surface of said base substrate layer further comprises dispensing said coating with one of a slot coater, a curtain coater, a cascade coater, a blade coater, a rod coater, a gravure coater, a Mylar rod coater, or a wired coater.

19. The method of claim 17, wherein said step of providing a base substrate comprises providing one of a resin coated base, a clear film, a baryta paper, a polyethylene-coated paper, a voided polyester, a pigmented paper, a cast-coated paper, or a metal foil.

20. The method of claim 17, wherein said step of combining a high surface area fumed alumina with a high molecular weight polyvinyl alcohol binder to form a coating further comprises:
acquiring a high surface area alumina powder;
preparing a dispersant;
mixing said high surface area alumina powder in said dispersant to form an alumina dispersion; and
combining said alumina dispersion with a high molecular weight PVA binder solution to form said coating.

21. The method of claim 20, wherein said step of preparing a dispersant further comprises combining an acetic acid solution in deionized water.

22. The method of claim 20, wherein said step of mixing said high surface area alumina powder in said dispersant to form an alumina dispersion comprises mixing said high area fumed alumina powder into said dispersant using a partially baffled mixing tank and a low to medium shear disperser.

23. A system for generating an image comprising:
an image receiving structure; and
an inkjet material dispenser;
wherein said image receiving structure includes a base substrate, and a microporous coating formed on said base substrate, wherein said microporous coating includes a high surface area fumed alumina and a high molecular weight polyvinyl alcohol (PVA) binder.

24. The system of claim 23, wherein said base substrate comprises one of a resin coated base, a clear film, a baryta paper, a polyethylene-coated paper, a voided polyester, a pigmented paper, a cast-coated paper, or a metal foil.

25. The system of claim 23, wherein said high surface area fumed alumina has an aggregate size between approximately 100 and 110 nm.

26. The system of claim 23, wherein said high surface area fumed alumina has a surface area greater than approximately 110 m²/gram.

27. The system of claim 23, wherein said high molecular weight PVA binder comprises a molar mass greater than approximately 300,000 grams per mol.

28. The system of claim 23, wherein said inkjet material dispenser comprises one of a thermally actuated inkjet dispenser, a mechanically actuated inkjet dispenser, an electrostatically actuated inkjet dispenser, a magnetically actuated dispenser, a piezoelectrically actuated dispenser, or a continuous inkjet dispenser.
